(19) United States
(12) Patent Application Publication
(10) Pub. No.: US 2025/0062508 A1
(43) Pub. Date: Feb. 20, 2025

(54) BATTERY

(71) Applicant: TOYOTA JIDOSHA KABUSHIKI KAISHA, Toyota-shi (JP)

(72) Inventor: Kenichi KAKISHITA, Nagoya-shi (JP)

(73) Assignee: TOYOTA JIDOSHA KABUSHIKI KAISHA, Toyota-shi (JP)

(21) Appl. No.: 18/643,005

(22) Filed: Apr. 23, 2024

(30) Foreign Application Priority Data
Aug. 14, 2023 (JP) 2023-131891

(51) Int. Cl. H01M 50/564; H01M 10/04; H01M 50/528

(52) U.S. Cl. CPC H01M 50/564; H01M 10/0431; H01M 50/528

(57) ABSTRACT

A battery of the present disclosure includes: an electrode stack; a current collector foil extending from a side surface portion of the electrode stack; a current collector terminal electrically connected to the current collector foil; and a laminate film in which the electrode stack and the current collector terminal that are wound together are sealed. Further, the current collector terminal constituting the battery of the present disclosure has a bonding region bonded to the current collector foil, and the bonding region has a contact portion in contact with the current collector foil and a non-contact portion not in contact with the current collector foil.

### CROSS-REFERENCE TO RELATED APPLICATION

This application claims priority to Japanese Patent Application No. 2023-131891 filed on Aug. 14, 2023, incorporated herein by reference in its entirety.

### BACKGROUND

### 1. Technical Field

The present disclosure relates to batteries.

### 2. Description of Related Art

There are known batteries including an electrode stack, current collector terminals, and a laminate film in which the electrode stack and the current collector terminals that are wound together are sealed. In such batteries, it is common to perform the sealing after heat welding the laminate film to the current collector terminals. In this regard, techniques have been developed to reduce the welding time for the heat welding.

For example, Japanese Unexamined Patent Application Publication No. 2005-056815 (JP 2005-056815 A) discloses a method for producing a secondary battery. In this method, when heat welding a laminate film to current collector terminals, the current collector terminals are pressed with a heating element to preheat the current collector terminals.

### SUMMARY

It is an object of the present disclosure to provide a battery in which a laminate film is efficiently welded to a current collector terminal even without preheating.

The disclosers found that the above issue can be solved by the following means.

### First Aspect

A battery including:
an electrode stack;
a current collector foil extending from a side surface portion of the electrode stack;
a current collector terminal electrically connected to the current collector foil; and
a laminate film in which the electrode stack and the current collector terminal that are wound together are sealed, wherein
the current collector terminal includes a bonding region bonded to the current collector foil, and
the bonding region includes a contact portion that is in contact with the current collector foil and a non-contact portion that is not in contact with the current collector foil.

### Second Aspect

In the battery according to the first aspect,
the current collector terminal has an uneven surface in the bonding region,
the contact portion is provided by a protruding portion of the current collector terminal and
the current collector foil being bonded together, and
the non-contact portion is provided by a recessed portion of the current collector terminal and the current collector foil not being bonded together.

### Third Aspect

In the battery according to the first aspect,
the current collector terminal includes a roughened portion in the bonding region, and
the non-contact portion is provided by the roughened portion and the current collector foil not being bonded together.

### Fourth Aspect

In the battery according to any one of the first to third aspects,
a ratio of an area of the contact portion to an area of the bonding region is higher than 0.0 and lower than 1.0.

According to the present disclosure, it is possible to provide a battery in which a laminate film is efficiently welded to a current collector terminal even without preheating.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view illustrating part of a battery of the present disclosure;

FIG. 2 is a schematic side view illustrating part of the battery of the present disclosure;

FIG. 3A is a schematic side view illustrating part of the battery of the present disclosure;

FIG. 3B is a schematic side view illustrating part of the battery of the present disclosure;

FIG. 4 is a schematic side view illustrating part of the battery of the present disclosure;

FIG. 5A is a schematic side view illustrating part of a battery of related art;

FIG. 5B shows a state in which heat applied to a laminate film moves from a current collector terminal to an electrode stack through a current collector foil when the laminate film is thermally welded to a current collector terminal in the battery of the related art; and

FIG. 6 is a graph showing the time required to reach the welding temperature when heat welding a laminate film to a current collector terminal in the case where the current collector terminal (A in the figure) according to the battery of the present disclosure shown in FIG. 2 and the current collector terminal (B in the figure) according to the battery of the related art shown in FIGS. 5A and 5B are used.

### DETAILED DESCRIPTION OF EMBODIMENTS

Hereinafter, embodiments of the present disclosure will be described in detail. It should be noted that the present disclosure is not limited to the following embodiments, and various modifications can be made within the scope of the gist of the disclosure.

### Battery

The battery of the present disclosure includes: an electrode stack; a current collector foil extending from a side surface portion of the electrode stack; a current collector terminal electrically connected to the current collector foil; and a laminate film in which the electrode stack and the current collector terminal that are wound together are sealed. Further, the current collector terminal constituting the battery of the present disclosure has a bonding region bonded to the current collector foil, and the bonding region has a contact portion in contact with the current collector foil and a non-contact portion not in contact with the current collector foil.

In a battery including an electrode stack, a current collector terminal, and a laminate film in which the electrode stack and the current collector terminal that are wound together are sealed, there is a problem that welding of the laminate film to the current collector terminal does not proceed efficiently. The disclosers etc. considered that one of the causes of the above problem is that heat applied to the laminate film for welding moves from the current collector terminal to the electrode stack through a portion where the current collector terminal and the current collector foil are in contact with each other.

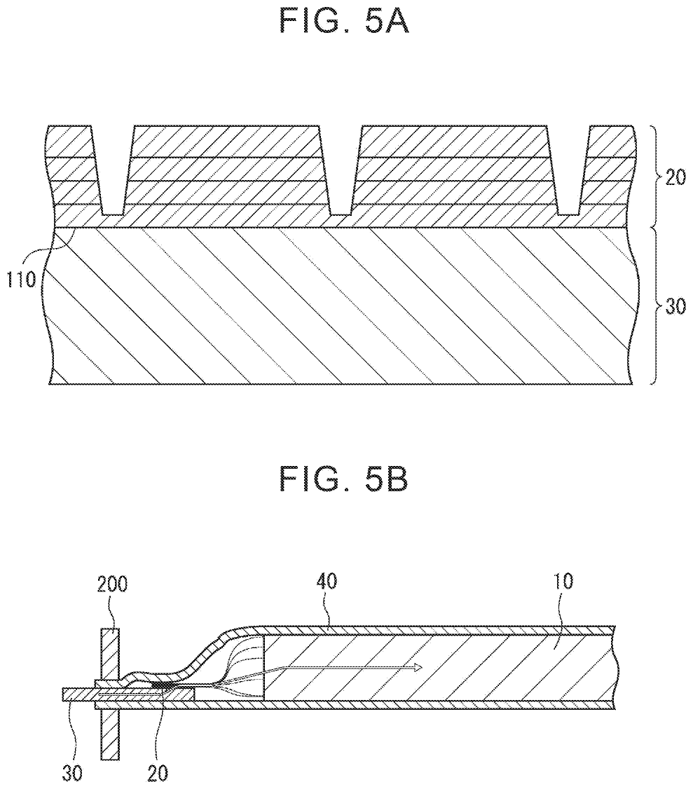

As shown in FIG. 5A, when the current collector terminal 30 does not have the non-contact portion 120, the laminate film 40 may be welded to the current collector terminal 30 as shown in FIG. 5B. In this case, it is considered that the heat applied to the laminate film 40 by the heating element 200 moves as indicated by an arrow, that is, moves from the current collector terminal 30 to the electrode stack 10 through the current collector foil 20.

In this regard, the Disclosers have found that the current collector terminal has a contact portion that is in contact with the current collector foil and a non-contact portion that is not in contact with the current collector foil, so that the laminate film can be efficiently welded to the current collector terminal even when preheating is not performed. This is considered to be because the current collector terminal has the contact portion, thereby ensuring electrical conduction from the electrode stack to the current collector terminal from the electrode stack, and having the non-contact portion can suppress the transfer of heat from the current collector terminal to the electrode stack. However, it is not intended to be bound by any theory.

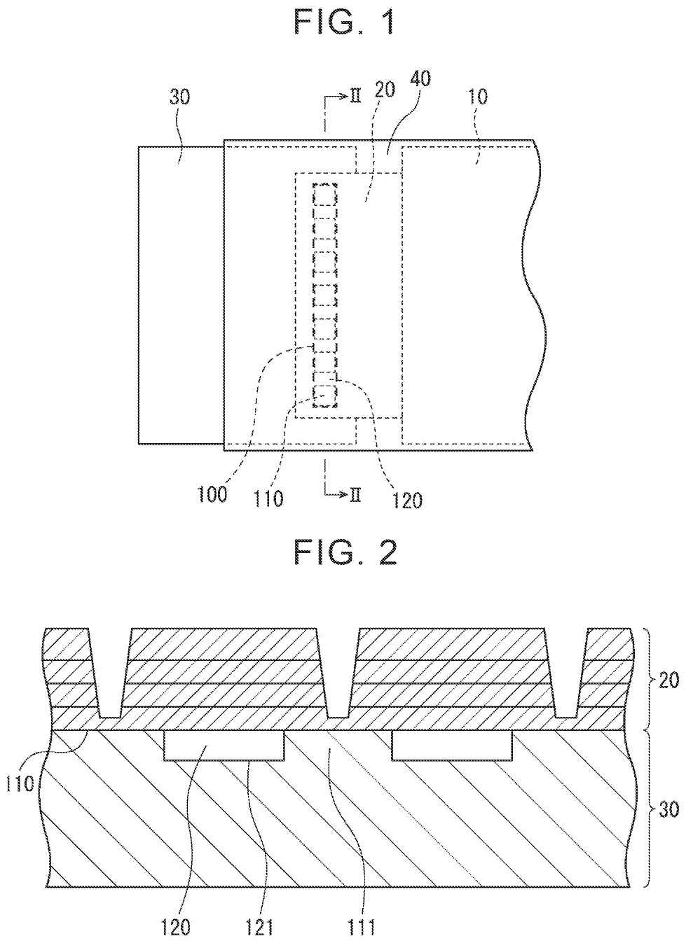

Hereinafter, a battery of the present disclosure will be described with reference to FIG. 1. FIG. 1 is a schematic plan view illustrating a part of a battery in a case where the battery in the present disclosure is viewed in plan view from a stacking direction of an electrode stack. In FIG. 1 and other drawings, dimensional relationships (length, width, thickness, etc.) do not reflect actual dimensional relationships.

As shown in FIG. 1, a battery 1 of the present disclosure includes an electrode stack 10, a current collector foil 20, a current collector terminal 30, and a laminate film 40 in which the electrode stack 10 and the current collector terminal 30 that are wound together are sealed. The current collector foil 20 extends from a side surface portion of the electrode stack 10. The current collector terminal 30 is electrically connected to the current collector foil.

### Electrode Stack

The electrode stack 10 functions as a power generation element of the battery 1. The shape of the electrode stack 10 is not particularly limited. However, the electrode stack 10 has, for example, a top surface portion, a bottom surface portion facing the top surface portion, and four side surface portions connecting the top surface portion and the bottom surface portion. The electrode stack 10 may include a positive electrode current collector, a positive electrode active material layer, an electrolyte layer, a negative electrode 10 active material layer, and a negative electrode current collector in this order.

### Current Collector Foil

The current collector foil 20 extends from a side surface portion of the electrode stack 10. The current collector foil 20 may be a bundle of portions of the positive electrode current collector of the electrode stack 10 where other layers are not laminated, and a bundle of portions of the negative electrode current collector of the electrode stack 10 where other layers are not laminated.

### Current Collector Terminal

The current collector terminal 30 is electrically connected to the current collector foil 20. The material of the current collector terminal 30 is not particularly limited as long as it is a material having a current collector function. For example, the material of the current collector terminal 30 may be the same metal material as that of the positive electrode current collector and the negative electrode current collector.

The current collector terminal 30 has a bonding region 100 bonded to the current collector foil 20. The bonding region 100 has a contact portion 110 in contact with the current collector foil 20 and a non-contact portion 120 not in contact with the current collector foil 20. The bonding region 100 in the current collector terminal 30 is a region formed by linearly connecting the contact portions 110 so as to be the smallest region including all of the contact portions 110.

### Laminate Film

The electrode stack 10 and the current collector terminal 30 are wound together, and the electrode stack 10 together with the current collector terminal 30 are sealed in the laminate film 40. The laminate film 40 may include a weld layer and a metal layer. The laminate film 40 can weld the welding layer and the current collector terminal 30. The material of the welding layer is not particularly limited as long as it is a material to be welded to the current collector terminal. The material of the welding layer may be, for example, a resin that can be thermally welded to the current collector terminal.

FIG. 2 is a schematic side view illustrating part of the battery 1 of the present disclosure. FIG. 2 is a diagram showing the configuration of the current collector foil 20 and the current collector terminal 30 in II-II cross section of FIG. 1. As shown in FIG. 2, the current collector terminal 30 of the battery 1 of the present disclosure has an uneven surface in the bonding region. The contact portion 110 may be provided by the protruding portion 111 of the current collector terminal 30 and the current collector foil 20 being bonded together. In addition, the non-contact portion 120 may be provided by the recessed portion 121 of the current collector terminal 30 and the current collector foil 20 not being bonded together.

An example of a method of forming the uneven surface in the bonding region of the current collector terminal 30 is a method of press-molding the current collector terminal 30.

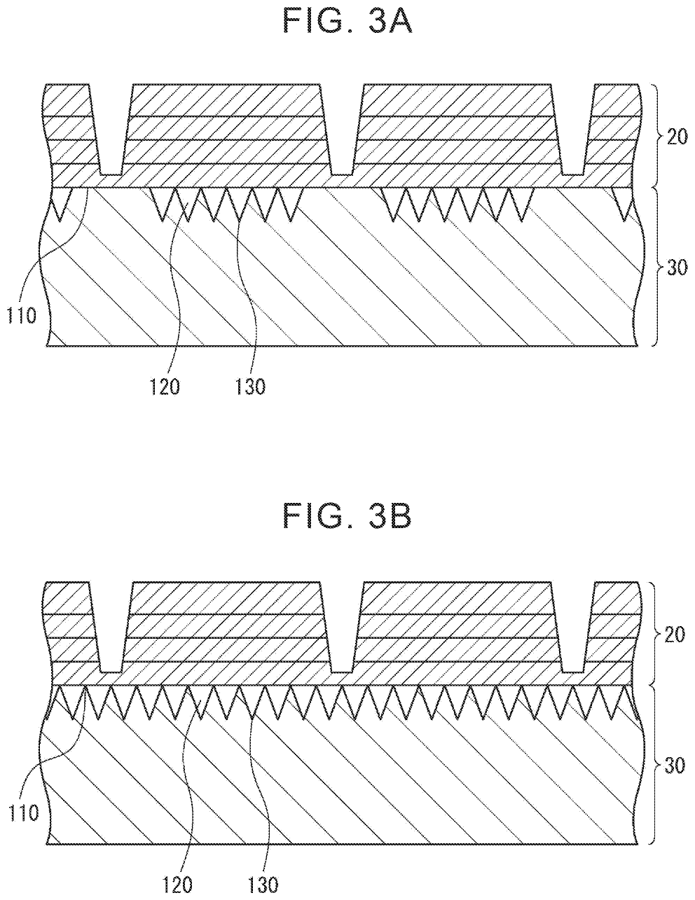

FIGS. 3A and 3B are each a schematic side view illustrating a part of the battery 1 according to the present disclosure. As shown in FIG. 3A, the current collector terminal 30 constituting the battery 1 of the present disclosure includes a roughened portion 130 in the bonding region. The non-contact portion 120 may be formed by the roughened portion 130 and the current collector foil 20 not being bonded to each other.

Further, as shown in FIG. 3B, the current collector terminal 30 constituting the battery 1 of the present disclosure includes the roughened portion 130 in the bonding region. The contact portion 110 may be provided by the roughened portion 130 and the current collector foil 20 being bonded together.

That is, in the embodiment including the roughened portion 130, a portion corresponding to the contact portion 110 of the current collector terminal 30 may be subjected to the roughening treatment or may not be subjected to the roughening treatment.

A method of forming the roughened portion 130 in the bonding region of the current collector terminal 30 is not particularly limited, and a method commonly known as a method of roughening a metal can be used. Examples of such a method include mechanical treatment such as polishing, physical treatment such as laser irradiation, electrochemical treatment such as anodizing, and chemical treatment such as wet etching.

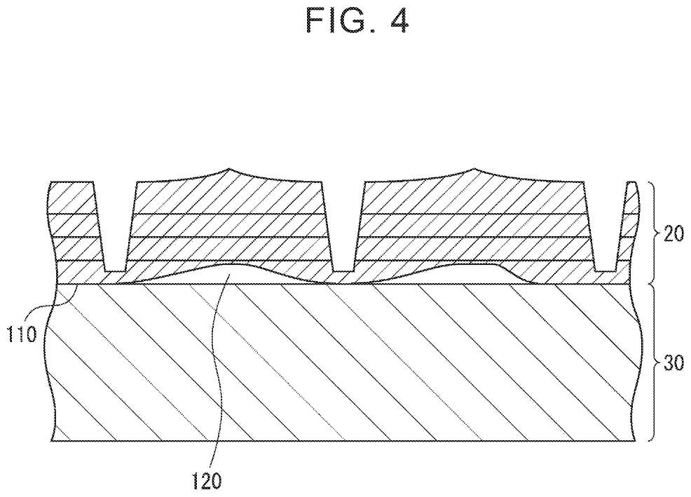

FIG. 4 is a schematic side view illustrating part of the battery 1 of the present disclosure. FIG. 4 illustrates a battery using the current collector terminal 30 that is not processed, processed, or the like on the surface. Even in a case where the current collector terminal 30 that has not been processed, processed, or the like is used for the surface, the current collector terminal 30 can be a battery having the contact portion 110 and the non-contact portion 120 by preventing the current collector foil 20 from contacting a portion other than the junction portion with the current collector terminal 30.

For example, the resin is disposed in the bonding region of the current collector terminal 30, and the portion where the resin is not disposed and the current collector foil 20 are bonded to each other. Thereafter, the resin is pulled out or melted to disappear, whereby the non-contact portion 120 can be formed in the current collector terminal 30.

In the above, a mode in which the non-contact portion is formed by a space provided between the current collector terminal and the current collector foil has been described. However, the non-contact portion may be formed by a low thermal conductivity member disposed between the current collector foil and the current collector terminal. That is, although not particularly illustrated, the current collector terminal includes a low thermal conductivity member disposed in the bonding region. The contact portion may be provided by a portion where the low thermal conductivity member is not disposed and the current collector foil being bonded together. In addition, the non-contact portion may be formed of a low thermal conductivity member.

The low thermal conductivity member is not particularly limited as long as it is a material having a lower thermal conductivity than the material constituting the current collector terminal and the current collector foil, and examples thereof include resins and the like.

The ratio of the area of the contact portion to the area of the bonding region (area of the contact portion/area of the bonding region) may be higher than 0.0 and lower than 1.0. This ratio may be 0.1 or more, 0.2 or more, 0.3 or more, or 0.4 or more, and may be 0.9 or less, 0.8 or less, 0.7 or less, or 0.6 or less. This ratio may be 0.5. This ratio is preferably low from the viewpoint that heat applied to the laminate film when the laminate film is welded to the current collector terminal is less likely to move from the current collector terminal to the electrode stack through the current collector foil. This ratio is preferably high from the viewpoint of facilitating bonding of the current collector foil and the current collector terminal.

The ratio of the area of the contact portion to the area of the bonding region can be adjusted by, for example, controlling the area of the recessed portion and the area of the roughened portion.

A method of bonding the current collector terminal and the current collector foil is not particularly limited, but an example of a method of bonding by ultrasonic waves is exemplified.

A method of welding the laminate film to the current collector terminal is not particularly limited, but a method of heat welding is exemplified. According to this method, the welding temperature can be determined by the melting point of the material used as the welding layer of the laminate film. Also, the time to reach the welding temperature may be greater than 0 seconds, less than 80 seconds, less than 70 seconds, or less than 60 seconds.

The battery in the present disclosure may be a lithium-ion secondary battery. Applications of batteries include, for example, power supplies for vehicles such as hybrid electric vehicle (HEV), plug-in hybrid electric vehicle (PHEV), battery electric vehicle (BEV), gasoline-powered vehicles, and diesel-powered vehicles. In particular, it is preferably used as a power supply for driving of hybrid electric vehicle (HEV), plug-in hybrid electric vehicle (PHEV), or battery electric vehicle (BEV). Also, the battery in the present disclosure may be used as a power source for mobile bodies other than vehicles (for example, railroads, ships, and aircraft), and may be used as a power source for electric products such as an information processing device.

### Bonding of Current Collector Terminal and Current Collector Foil

### Example 1

A current collector terminal having the shape shown in FIG. 2 was manufactured by press molding. The thickness from the bottom surface of the current collector terminal to the tip end of the protruding portion was 2 mm. In addition, as the current collector foil, 30 aluminum foils (Al050) of 12 μm were laminated. A stack of aluminum foil was placed on the current collector terminal, and the current collector terminal and the current collector foil were bonded by ultrasonic bonding using a horn having a tip size of 1 mm. The spacing between the bonded portions was 2 mm. In addition, the ratio of the area of the contact portion to the area of the bonding region (area of the contact portion/area of the bonding region) was 0.5.

### Comparative Example 1

The current collector terminal and the current collector foil were bonded in the same manner as in Example 1 except that the current collector terminal having the shape shown in FIG. 5A was used. The ratio of the area of the contact portion to the area of the bonding region (area of the contact portion/area of the bonding region) was 1.

### Evaluation

The current collector terminal of each example was covered with a laminate film, and heat was applied to the laminate film, and the time until the current collector terminal reached the welding temperature of 160° C. was measured. The material of the welded layer of the laminate film was polypropylene.

### Results

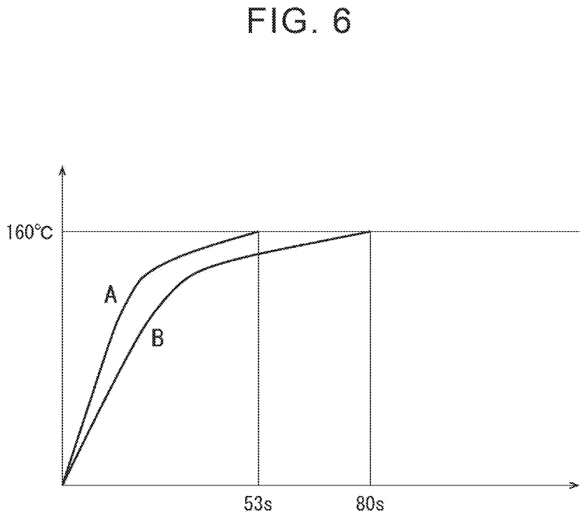

The results of the above evaluation are shown in Table 1 and FIG. 6.

TABLE 1

| | Area of Contact | Time to |
|---|---|---|
| | Portion/Area of | Reach Welding |
| | Bonding Region | Temperature (s) |
| Example 1 | 0.5 | 53 |
| Comparative | 1.0 | 80 |
| Example 1 | | |

In Example 1 using an article in which the current collector terminal whose ratio of the area of the contact portion to the area of the bonding region (area of the contact portion/area of the bonding region) is 0.5 and the current collector foil are bonded together, the time required for the current collector terminal to reach the welding temperature was short. This is shown in Table 1 and FIG. 6. The current collector terminal whose ratio of the area of the contact portion to the area of the bonding region (area of the contact portion/area of the bonding region) is 0.5 is a current collector terminal having a contact portion and a non-contact portion.

What is claimed is:

1. A battery, comprising:
an electrode stack;
a current collector foil extending from a side surface portion of the electrode stack;
a current collector terminal electrically connected to the current collector foil; and
a laminate film in which the electrode stack and the current collector terminal that are wound together are sealed, wherein
the current collector terminal includes a bonding region bonded to the current collector foil, and
the bonding region includes a contact portion that is in contact with the current collector foil and a non-contact portion that is not in contact with the current collector foil.

2. The battery according to claim 1, wherein
the current collector terminal has an uneven surface in the bonding region,
the contact portion is provided by a protruding portion of the current collector terminal and the current collector foil being bonded together, and
the non-contact portion is provided by a recessed portion of the current collector terminal and the current collector foil not being bonded together.

3. The battery according to claim 1, wherein
the current collector terminal includes a roughened portion in the bonding region, and
the non-contact portion is provided by the roughened portion and the current collector foil not being bonded together.

4. The battery according to claim 1, wherein a ratio of an area of the contact portion to an area of the bonding region is higher than 0.0 and lower than 1.0.
